(19) United States
(12) Patent Application Publication
(10) Pub. No.: US 2024/0314777 A1
(43) Pub. Date: Sep. 19, 2024

(54) RETRANSMITTING PORTIONS OF A TRANSPORT BLOCK

(71) Applicant: Lenovo (Singapore) Pte. Ltd., New Tech Park (SG)

(72) Inventors: Ankit Bhamri, Rödermark (DE); Vijay Nangia, Woodridge, IL (US)

(21) Appl. No.: 18/681,211

(22) PCT Filed: Aug. 4, 2022
(86) PCT No.: PCT/IB2022/057270

§ 371 Date: Feb. 5, 2024

Related U.S. Application Data
(60) Provisional application No. 63/229,262, filed on Aug. 4, 2021.

(51) Int. Cl. H04W 72/1268; H04L 1/08

(52) U.S. Cl. CPC H04W 72/1268; H04L 1/08

(57) ABSTRACT

Apparatuses, methods, and systems are disclosed for retransmitting portions of a transport block (“TB”). One method includes receiving, at a device, a first scheduling grant that schedules transmission of a TB on a physical channel over multiple TTIs. The method includes receiving information to determine a number of portions of the multiple TTIs, determine a number of TTIs associated with each portion of the number of portions of the multiple TTIs, or a combination thereof. The method includes receiving a second scheduling grant that indicates at least one portion of the number of portions of the multiple TTIs to be retransmitted.

### CROSS-REFERENCE TO RELATED APPLICATIONS

This application claims priority to U.S. Patent Application Ser. No. 63/229,262 entitled “APPARATUSES, METHODS, AND SYSTEMS FOR PUSCH RETRANSMISSIONS FOR A SINGLE TB OVER MULTIPLE SLOTS” and filed on Aug. 4, 2021 for Ankit Bhamri et al., which is incorporated herein by reference in its entirety.

### FIELD

The subject matter disclosed herein relates generally to wireless communications and more particularly relates to retransmitting portions of a transport block (“TB”).

### BACKGROUND

In some wireless communications systems, a single TB may be transmitted over multiple slots. In such systems, the TB may have to be retransmitted.

### BRIEF SUMMARY

Methods for retransmitting portions of a TB are disclosed. Apparatuses and systems also perform the functions of the methods. One embodiment of a method includes receiving, at a device, a first scheduling grant that schedules transmission of a TB on a physical channel over multiple transmission time intervals (“TTIs”). In some embodiments, the method includes receiving information to determine a number of portions of the multiple TTIs, determine a number of TTIs associated with each portion of the number of portions of the multiple TTIs, or a combination thereof. In certain embodiments, the method includes receiving a second scheduling grant that indicates at least one portion of the number of portions of the multiple TTIs to be retransmitted.

One apparatus for retransmitting portions of a TB includes a receiver to: receive a first scheduling grant that schedules transmission of a TB on a physical channel over multiple TTIs: receive information to determine a number of portions of the multiple TTIs, determine a number of TTIs associated with each portion of the number of portions of the multiple TTIs, or a combination thereof; and receive a second scheduling grant that indicates at least one portion of the number of portions of the multiple TTIs to be retransmitted.

Another embodiment of a method for retransmitting portions of a TB includes transmitting, at a device, a first scheduling grant that schedules transmission of a TB on a physical channel over multiple TTIs. In some embodiments, the method includes transmitting information to determine a number of portions of the multiple TTIs, determine a number of TTIs associated with each portion of the number of portions of the multiple TTIs, or a combination thereof. In certain embodiments, the method includes transmitting a second scheduling grant that indicates at least one portion of the number of portions of the multiple TTIs to be retransmitted.

Another apparatus for retransmitting portions of a TB includes a transmitter to: transmit a first scheduling grant that schedules transmission of a TB on a physical channel over multiple TTIs: transmit information to determine a number of portions of the multiple TTIs, determine a number of TTIs associated with each portion of the number of portions of the multiple TTIs, or a combination thereof; and transmit a second scheduling grant that indicates at least one portion of the number of portions of the multiple TTIs to be retransmitted.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for retransmitting portions of a TB;

FIG. 2 is a schematic block diagram illustrating one embodiment of an apparatus that may be used for retransmitting portions of a TB;

FIG. 3 is a schematic block diagram illustrating one embodiment of an apparatus that may be used for retransmitting portions of a TB;

FIG. 4 is a timing diagram illustrating one embodiment of retransmission of portions if TB over multiple slots (“TBoMS”) is applied and only a single transmission occasion for TBoMS (“TOT”) exists;

FIG. 5 is a timing diagram illustrating one embodiment of retransmission of portions if TBoMS is applied and multiple TOTs exists;

FIG. 6 is a timing diagram illustrating one embodiment of an early retransmission indication for partial TBoMS;

FIG. 7 is a flow chart diagram illustrating one embodiment of a method for retransmitting portions of a TB; and

FIG. 8 is a flow chart diagram illustrating another embodiment of a method for retransmitting portions of a TB.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

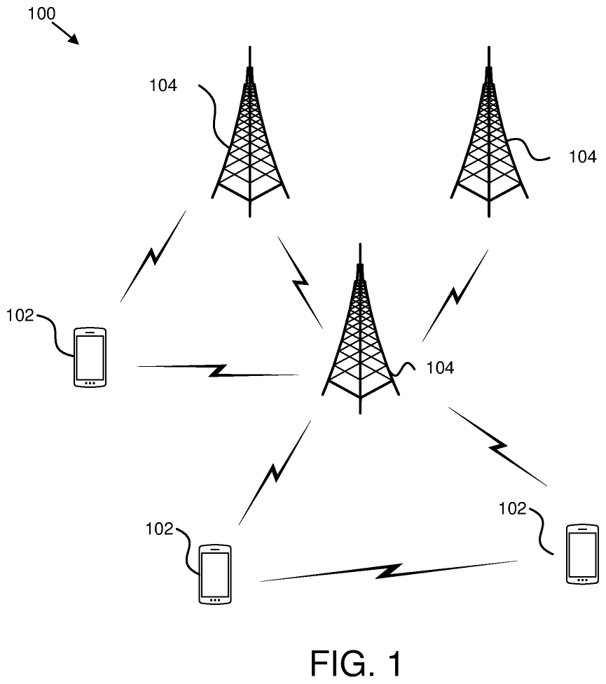

FIG. 1 depicts an embodiment of a wireless communication system 100 for retransmitting portions of a TB. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, an integrated access and backhaul node (“IAB-node”), a relay node, a network controlled repeater node (“NCR”), a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a first scheduling grant that schedules transmission of a TB on a physical channel over multiple TTIs. In some embodiments, the remote unit 102 may receive information to determine a number of portions of the multiple TTIs, determine a number of TTIs associated with each portion of the number of portions of the multiple TTIs, or a combination thereof. In certain embodiments, the remote unit 102 may receive a second scheduling grant that indicates at least one portion of the number of portions of the multiple TTIs to be retransmitted. Accordingly, the remote unit 102 may be used for retransmitting portions of a TB.

In certain embodiments, a network unit 104 may transmit a first scheduling grant that schedules transmission of a TB on a physical channel over multiple TTIs. In some embodiments, the network unit 104 may transmit information to determine a number of portions of the multiple TTIs, determine a number of TTIs associated with each portion of the number of portions of the multiple TTIs, or a combination thereof. In certain embodiments, the network unit 104 may transmit a second scheduling grant that indicates at least one portion of the number of portions of the multiple TTIs to be retransmitted. Accordingly, the network unit 104 may be used for retransmitting portions of a TB.

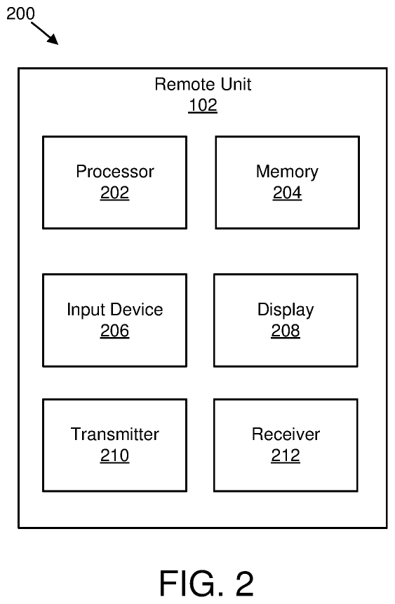

FIG. 2 depicts one embodiment of an apparatus 200 that may be used for retransmitting portions of a TB. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to: receive a first scheduling grant that schedules transmission of a TB on a physical channel over multiple TTIs: receive information to determine a number of portions of the multiple TTIs, determine a number of TTIs associated with each portion of the number of portions of the multiple TTIs, or a combination thereof; and receive a second scheduling grant that indicates at least one portion of the number of portions of the multiple TTIs to be retransmitted.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

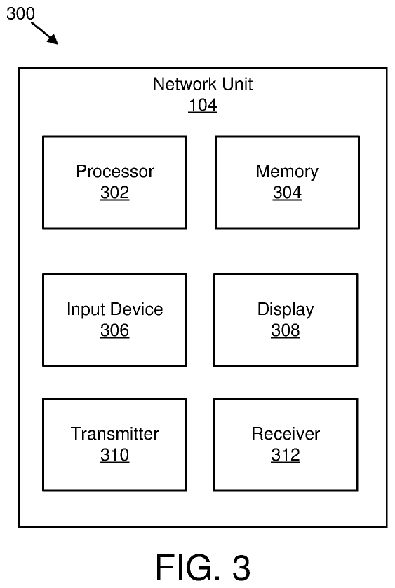

FIG. 3 depicts one embodiment of an apparatus 300 that may be used for retransmitting portions of a TB. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the transmitter 310 to: transmit a first scheduling grant that schedules transmission of a TB on a physical channel over multiple TTIs: transmit information to determine a number of portions of the multiple TTIs, determine a number of TTIs associated with each portion of the number of portions of the multiple TTIs, or a combination thereof: and transmit a second scheduling grant that indicates at least one portion of the number of portions of the multiple TTIs to be retransmitted.

It should be noted that one or more embodiments described herein may be combined into a single embodiment.

In certain embodiments, transmission of a single TBoMS may be used. This may allow for improved coverage for a physical uplink shared channel (“PUSCH”). In such embodiments, slots may be non-contiguous depending up on a time division duplexing (“TDD”) configuration and/or unavailability of certain slots for PUSCH transmission. In some embodiments, retransmissions may be made when a TB is scheduled over multiple slots. In such embodiments, only a portion of a TBoMS transmission may experience a different level of interference compared to other portions. The interference may be caused by deep fading, fast fading, and so forth. Accordingly, it may not be optimal to transmit an entire TB over multiple slots. Even for a smaller TB size, multiple slots may be scheduled for transmission and, therefore, a code block group (“CBG”) based PUSCH retransmissions might not work. Therefore, in various embodiments, there may be enhancements to handle PUSCH retransmissions when TBoMS is applied.

In some embodiments, the following 2 options for time domain resource determination for TBoMS may be used for down-selection: 1) option 1: time domain resource determination for TBoMS may be performed only via PUSCH repetition Type A like time domain resource allocation (“TDRA”); and 2) option 2: time domain resource determination for TBoMS may be performed via PUSCH repetition Type A like TDRA or via PUSCH repetition Type B like TDRA. The use of PUSCH repetition Type B like TDRA for time domain resource determination may be according to an additional UE capability for a TBoMS capable UE. In various embodiments, there may be a demodulation reference signal (“DMRS”) pattern for PUSCH repetition Type B like TDRA.

In various embodiments, there may be a TOT that includes at least one slot or multiple consecutive physical slots for UL transmission. In such embodiments, TOT may be used for designing aspects related to signal generation (e.g., rate-matching, power control, and so forth). Moreover, in such embodiments, concepts may be specified or may not be.

In certain embodiments, a structure of TBoMS may be according to only one of two options: 1) if a design based on single RV is used: and 2) if a design based on different RVs is used. In such embodiments, rate-matching, transport block size (“TBS”) determination, collision handling, and so forth may be determined. Moreover, a single redundancy version (“RV”) may not be constrained to have only the same coded bits in each slot or in each TOT. The concept of TOT may used to define design options and may or may not be used to design other details (e.g., rate-matching, TBS determination, collision handling, and so forth).

In some embodiments, there may be time domain resource determination for TBoMS that may be performed only via PUSCH repetition Type A like TDRA. In such embodiments, whether or not optimizations for time domain resource determination are necessary for allocating resource in the S slots for an unpaired spectrum case may be determined.

In various embodiments, resources for TBoMS may be allocated in a special slot in TDD according to an agreed time domain resource determination for TBoMS.

In certain embodiments, the following three options for rate-matching for TBoMS may be used for down-selection, where only one option may be selected: 1) rate-matching is performed per slot: 2) rate matching is performed continuously across all the allocated slots per TOT: and 3) rate matching is performed continuously across all the allocated slots and/or TOTs for TBoMS. In such embodiments, “rate-matching is performed per X” means that the time unit for the bit selection and bit interleaving is X. Moreover, these three options may imply that the UL resource in the time unit may or may not be consecutive (e.g., depending on the given option).

In some embodiments, a number of slots allocated for TBoMS is determined by using a row index of a TDRA list which is configured via radio resource control (“RRC”) signaling.

In various embodiments, non-consecutive physical slots for uplink (“UL”) transmission can be used to transmit TBoMS at least for an unpaired spectrum. It may be determined how TBoMS is transmitted over non-consecutive physical slots for UL transmission for unpaired spectrum. Further, it may be determined whether and how non-consecutive physical slots for UL transmission may be used to transmit TBoMS for paired spectrum and a supplemental uplink (“SUL”) band as well.

In certain embodiments, the concept of TOT is used for the purpose of discussion, where a TOT includes time domain resources which may or may not span multiple slots. In such embodiments, it may be determined whether multiple slots which constitute a TOT are consecutive or non-consecutive physical slots for UL transmissions. Moreover, in such embodiments, such concepts may or may not be specified.

In some embodiments, for a single TBoMS there may be a down select among the following options: 1) only one TOT is determined for a TBoMS—the TB is transmitted on the TOT using a single RV—it may be determined whether and how the single RV is rate matched across the TOT (e.g., continuous rate-matching across the TOT, rate matched for each slot, and so forth): 2) only one TOT is determined for a TBoMS—the TB is transmitted on the TOT using different RVs—it may be determined how an RV index is refreshed within the TOT (e.g., after each slot boundary, at every jump between two non-contiguous resources if any, and so forth): 3) multiple TOTs are determined for a TBoMS—the TB is transmitted on the multiple TOTs using a single RV—it may be determined how the single RV is rate matched across single or multiple TOTs (e.g., rate matched for each TOT, rate matched for all the TOTs, rate matched for each slot, and so forth): and 4) multiple TOTs are determined for a TBoMS—the TB is transmitted on the multiple TOTs using different RVs—it may be determined whether and how the RV index is refreshed within one TOT (e.g., after each slot boundary, at every jump between two non-contiguous resources if any, and so forth). It may be determined an exact TBS determination procedure. Moreover, it may be determined whether a single TBoMS can be repeated or not. Further, other implications may be determined (e.g., power control, collision handling, and so forth).

In various embodiments, for TBoMS, the maximum supported TBS may not exceed a legacy maximum supported TBS for the same number of layers. It may be determined details and further constraints on applicability of TBoMS.

In certain embodiments, there may be CBG based PUSCH retransmissions in new radio (“NR”). In NR, code block group-based retransmissions are supported for PUSCH. Basically, depending up on the TB size, the number of code blocks are created, and then the code blocks can be grouped together. Based on grouping, the retransmissions may be done only for certain CBGs rather than the entire TB. However, the retransmission may be dependent on the TB size rather the duration over which the TB is transmitted. In NR, a duration is usually a slot or a smaller.

Further details on CBG based PUSCH transmissions may be specified as found herein. In some embodiments, there may be code block group based PUSCH transmissions. In various embodiments, there may be a UE procedure for grouping of code blocks to code block groups.

In certain embodiments, if a UE is configured to transmit CBG based transmissions by receiving the higher layer parameter codeBlockGroupTransmission in PUSCH-ServingCellConfig, the UE may determine the number of CBGs for a PUSCH transmission as:

M=min(N,C),

where N is the maximum number of CBGs per transport block as configured by maxCodeBlockGroupsPerTransportBlock in PUSCH-ServingCellConfig, and C is the number of code blocks in the PUSCH.

$$M = {mod}_{1} ( C , M ) , {K}_{1} = [ \frac{C}{M} ] , and {K}_{2} = [ \frac{C}{M} ] .$$

If M₁>0, CBG m, m=0,1, . . . , M₁−1, consists of code blocks with indices mK₁+k, k=0,1, . . . , K₁−1. CBG m, m=M₁, M₁+1, . . . , M−1, consists of code blocks with indices M₁K₁+(m−M₁)K₂+k, k=0,1, . . . , K₂−1.

In various embodiments, there may be a UE procedure for transmitting code block group based transmissions. If a UE is configured to transmit code block group-based transmissions by receiving the higher layer parameter codeBlockGroupTransmission in PUSCH-ServingCellConfig: 1) for an initial transmission of a TB as indicated by the ‘New Data Indicator’ field of the scheduling DCI, the UE may expect that the CBG transmission information (“CBGTI”) field indicates all the CBGs of the TB are to be transmitted, and the UE shall include all the code block groups of the TB: and 2) for a retransmission of a TB as indicated by the ‘New Data Indicator’ field of the scheduling DCI, the UE shall include only the CBGs indicated by the CBGTI field of the scheduling DCI. A bit value of ‘0’ in the CBGTI field indicates that the corresponding CBG is not to be transmitted and ‘1’ indicates that it is to be transmitted. The order of CBGTI field bits is such that the CBGs are mapped in order from CBG #0 onwards starting from the MSB.

In certain embodiments, enhanced PUSCH retransmission is used if transmission of a single transport block over contiguous and/or non-contiguous slots is applied, where retransmission of only some section of the scheduled duration may be indicated and the granularity of the duration for which the retransmission can be done may depend on: 1) a maximum allowed and/or configured bits in UL grant to indicate retransmission: 2) a number of slots (e.g., contiguous or non-contiguous) scheduled for transmission of a single TB: 3) a number of segments that are non-contiguous, referred to as TOT: 4) a number of slots within each TOT: and/or 5) a number of indicated RVs and corresponding duration.

In some embodiments described herein, benefits may include: 1) scheduling retransmission for only specific portions of scheduled slots instead of retransmitting an entire block of slots: and 2) providing a more dynamic approach to determine a minimum duration for which retransmission can be indicated.

Various embodiments described herein may be discussed relating to a single TB transmission over multiple slots, but may be applicable to any transmission time interval (“TTI”) such as a mini slot. Further, certain embodiments described herein may be discussed relating to PUSCH TB transmission over multiple slots, but may be applicable to other physical channels. It should be noted that terms such as TBoMS and TOT may be used for case of description, but may be interchanged with other terminology as well.

In a first embodiment, there may be retransmissions with a single TOT (e.g., when all slots are contiguous for single TB transmission). According to the first embodiment, the following signaling and procedures may be used to indicate retransmission when TBoMS is applied with contiguous slots:

In a first step, a UE is pre-configured (e.g., with either a fixed configuration or semi-statically configured) with a maximum number of indices “N” that may be used to associate portions of multiple slots (e.g., entire duration) over which PUSCH TB may be scheduled for transmission. Basically “N” refers to maximum number of portions that can be created for which separate retransmission indication can be signaled by the network. In one example, “N” refers to maximum number of code block segments with the transport block including a single code block.

In a second step, the UE is configured and/or indicated to apply TBoMS (e.g., may be either via RRC, medium access control (“MAC”) control element (“CE”) (“MAC CE”), or downlink control information (“DCI”) (e.g., UL grant or some other DCI such as group-common DCI)).

In a third step, the UE receives a dynamic UL grant via DCI or a configured grant to transmit (e.g., initial transmission) a single TB over multiple slots, where the grant includes the indication for the number of slots (contiguous) “M”.

In a fourth step, upon receiving the grant, the UE determines the actual number of portions (or the number of code block segments) as n=“N” if N<=M, otherwise as n=min (N, M), if N>M.

In a fifth step, once the UE determines the actual number of portions, then it calculates the number of slots within each portion as m0, m1, m2, . . . mn−1, where m0+m1+ . . . +mn−1=M. An equal number of slots are distributed across each portion (e.g., whenever possible) such that m0=m1= . . . =mₙ₋₁, wherein the first mi slots can be associated with index 0 (e.g., for retransmission indication), next m₂ slots can be associated with index 1, and so forth. If an equal number of slots cannot be distributed across each portion, then the number of slots for each portion and/or segment can be determined by allocating one slot at a time to each portion and moving in a cyclic manner starting from a first portion and continue until a number of slots are exhausted. For example, if M=10 and n=N=3, then based on a proposed allocation, m₀=4, m₁=3, m₂=3. It should be noted that the above cyclic allocation is used only for the purpose of determining a number of slots within each portion, but which slots fall within each portion are done in sequential manner (e.g., first m₁ slots associated with index 0, next m₂ slots associated with index 1, and so forth).

In another example, the actual number of portions may be determined as:

$${M}_{1} = mod ( M , n ) , {K}_{1} = [ \frac{M}{n} ] , and {K}_{2} = [ \frac{M}{n} ] .$$

If M₁>0, portion m, m=0,1, . . . , M₁−1, consists of K₁ slots with indices mK₁+k, k=0,1, . . . , K₁−1. Portion m, m=M₁, M₁+1, . . . , n−1, consists of K₂ slots with indices M₁K₁+(m−M₁)K₂+k,k=0,1, . . . , K₂−1.

In a sixth step, the UE transmits the single TB PUSCH over multiple scheduled slots based on the grant from the gNB.

In a seventh step, the gNB receives and decodes the portions of the PUSCH and determines success of failure for each reception and may then send another grant to the UE without toggling the new data indicator (“NDI”) bit and with same hybrid automatic repeat request (“HARQ”) process number, and with an additional bitfield in the grant to indicate which of the portions of the multi-slot PUSCH needs to be retransmitted by signaling “0” corresponding to a portion if no retransmission is needed or signaling “1” corresponding to a portion and/or segment if retransmission is needed. In some examples, the portions of the multi-slot PUSCH correspond to the portions determined for the initial transmission of the transport block.

In an eighth step, upon receiving the grant for retransmission, the UE determines which portions need to be retransmitted based on an association of portions with the bit sequence (e.g., indices). For example, a most significant bit (“MSB”) to a least significant bit (“LSB”) corresponds to a last portion to a first portion or alternatively from the first portion to the last portion.

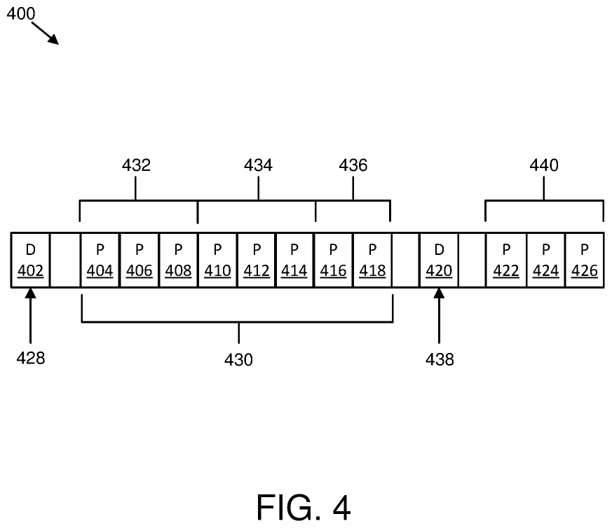

One embodiment for retransmission when TBoMS is applied with contiguous slots is shown in FIG. 4.

FIG. 4 is a timing diagram 400 illustrating one embodiment of retransmission of portions if TBoMS is applied and only a single TOT exists. The timing diagram 400 illustrates a first DCI (“D”) 402, PUSCH transmissions (“P”) 404, 406, 408, 410, 412, 414, 416, and 418, a second D 420, and P 422, 424, and 426. At a time 428, the D 402 is a DCI with TBoMS UL grant. A TBoMS 430 (M=8, n=3) includes P 404, 406, 408, 410, 412, 414, 416, and 418. The TBoMS 430 includes a first portion (portion 0 (m0=3)) 432 (e.g., P 404, 406, 408), a second portion (portion 1 (m1=3)) 434 (e.g., P 410, 412, 414), and a third portion (portion 2 (m2=2)) 436 (e.g., P 416, 418). At a time 438, the D 420 is a DCI with retransmission of only portion 0 432 (e.g., bit field can be “100”). A retransmission 440 includes P 422, 424, and 426 (e.g., retransmission of portion 0 (m0=3)).

In some embodiments, one or more combination of following may be done for the procedure of the first embodiment: 1) a maximum number of slots that can be contained within a portion may be pre-configured, semi-statically signaled, and/or dynamically indicated: 2) a minimum number of slots that can be contained within a portion are pre-configured, semi-statically signaled, and/or dynamically indicated: 3) if the UE is configured and/or indicated to apply TBoMS, then CBG based PUSCH transmissions are not applied: 4) a separate (e.g., new) bitfield in the UL grant is used to indicate which portions need to be retransmitted—bitfield size can be variable depending on scheduled slots for TBoMS, maximum allowed and/or calculated portions, minimum allowed and/or calculated portions, or some combination thereof: 5) an existing field such as CBGTI can be reused to indicate which portions need to be retransmitted, if CBG based PUSCH transmissions are not allowed—bitfield size can be variable depending on scheduled slots for TBoMS, maximum allowed and/or calculated portions, minimum allowed and/or calculated portions, or some combination thereof:

6) a number of portions and duration for each portion can be implicitly determined based on how RV is applied—if more than one RV is applied with RV cycling over the entire duration of slots, then each of the portion duration can be implicitly determined based on the RV indication and corresponding slots over which same RV is applied—for example, if RV0 is applied to first 2 slots, RV2 is applied to next 2 slots, then the first portion can be assumed to be over first 2 slots, second portion can be assumed to be over next 2 slots, and so forth—in another example, the number of portions and duration for each portion are determined based on the number of slots with the same RV—for example, with N=2, if RV0 is applied to first 2 slots then n=2 (min(N,2)) portions with each portion corresponding to each of the two slots associated to RV0, RV2 is applied to next 3 slots then n=2 (min(N,3)) portions with first portion corresponding to first and second slots of the three slots associated to RV2 and the second portion corresponding to third slot of the three slots associated to RV2—in another example, with N=3, if RV0 is applied to first 2 slots then n=2 (min(N,2)) portions with each portion corresponding to each of the two slots associated to RV0, RV2 is applied to next 3 slots then n=3 (min(N,3)) with each portion corresponding to each of the three slots associated to RV0—the maximum of portions is based on the value of N and the maximum number of slots associated with the same RV—the grant for retransmission (e.g., with NDI bit not toggled and same HARQ process number), indicates the RV in the RV-field and an additional bitfield in the grant indicating which of the portions of the multi-slot PUSCH corresponding to the indicated RV is to be retransmitted:

7) a number of portions and duration for each portion can be implicitly determined based on how rate-matching is applied—if rate matching is applied separately for each slot or a sub-set of slots, then the portion duration can be assumed to be over one slot or over a sub-set of slots, respectively: and 8) a number of portions and duration for each portion can be implicitly determined or can be configured and/or indicated based on the numerology. For example, if a larger subcarrier spacing (“SCS”) such as 480 kHz or 960 kHz is applied, then a larger number of slots within a portion can be contained in comparison to some smaller SCS such as 15 kHz or 30 KHz.

In a second embodiment, there may be retransmissions with multiple TOTs (e.g., when not all slots are contiguous for single TB transmission). In the second embodiment, signaling and procedures may be used to indicate retransmission when TBoMS is applied such that not all slots are contiguous and there are TOTs (e.g., disjointed set of contiguous slots):

In a first step, a UE is pre-configured (e.g., either fixed configuration or semi-statically configured) with maximum number of indices “N” that can be used to associate the portions of the multiple slots (e.g., entire duration) over which PUSCH TB can be scheduled for transmission. Basically “N” refers to maximum number of portions that can be created for which separate retransmission indication can be signaled by the network.

In a second step, the UE is configured and/or indicated to apply TBoMS (e.g., could be either via RRC, MAC CE, or DCI (e.g., UL grant or some other DCI such as group-common DCI)).

In a third step, the UE receives a dynamic UL grant via DCI or a configured grant to transmit a single TB over multiple slots, where the grant includes the indication for a number of slots “M”, where not all the slots are contiguous. Each portion that has contiguous slots may be referred to as one transmission occasion for TBoMS (TOT).

In a fourth step, upon receiving the grant, the UE determines the number of TOTs that can be referred to as “L” and the number of contiguous slots within each TOT that can be referred to as l₀, l₁, l₂, . . . , l_{L-1}, such that l₀+lₗ− . . . +l_{L-1}=M. Basically, a TOT can be assumed for a set of contiguous slots that are scheduled. For example, if there is a first set of contiguous slots with 3 slots, then this can be assumed as TOT₀ with l₀=3, then followed by second set of contiguous slots (but with a gap of at least one slot from the last slot of TOT₀) with 2 slots, then this can be assumed as TOT₁ with l₁=2.

In a fifth step, upon receiving the grant and determining the number of TOTs, the UE determines the actual number of portions as n=“N” if N<=M, otherwise as n=min (N, M), if N>M.

In a sixth step, upon determining the total number of portions n across an entire duration, the UE determines a number of portions for each of the TOTs and a corresponding number of slots within each of those portions as follows: 1) if n=L (e.g., number of portions is equal to number of TOTs), then each of the TOTs has one portion, where the number of slots within each portion is equal to number of slots within the corresponding TOT (e.g., l₀=m₀, l₁=m₁, and so forth): 2) if n>L (e.g., number of portions is greater than number of TOTs), then portions are created (e.g., one at a time) within each TOT in a cyclic manner starting from a first TOT and continue splitting TOT into multiple portions until the actual number of portions n are exhausted-for example, if n=5, L=2, then first TOT will have 3 portions and second TOT will have 2 portions: and 3) n<L is not allowed (e.g., at least a minimum number of portions should be equal to the number of TOTs).

In a seventh step, once the UE determines the actual number of portions within a TOT, then it calculates the number of slots within each portion within each TOT: 1) an equal number of slots are distributed across each portion (e.g., whenever possible): and 2) if an equal number of slots cannot be distributed across each portion, then the number of slots for each portion and/or segment can be determined by allocating one slot at a time to each portion and moving in cyclic manner starting from first portion and continue until number of slots are exhausted. It should be noted that the cyclic allocation is used not only for the purpose of determining a number of slots within each portion for each TOT, but also for which slots fall within each portion are done in sequential manner.

In an eighth step, the UE transmits the single TB PUSCH over multiple scheduled slots based on the grant from gNB.

In a nineth step, the gNB receives and decodes the portions of the PUSCH and determines success of failure for each reception and may then send another grant to the UE without toggling the NDI bit and with the same HARQ process number, and with an additional bitfield in the grant to indicate which of the portions of the multi-slot PUSCH need to be retransmitted by signaling “0” corresponding to a portion if no retransmission is needed or signaling “1” corresponding to a portion if retransmission is needed. In some examples, the portions of the multi-slot PUSCH correspond to the portions determined for the initial transmission of the transport block.

In a tenth step, upon receiving the grant for retransmission, the UE determines which portions need to be retransmitted based on an association of portions to the bit sequence (e.g., indices). For example, MSB to LSB corresponds respectively from a last portion to a first portion or alternatively from the first portion to the last portion.

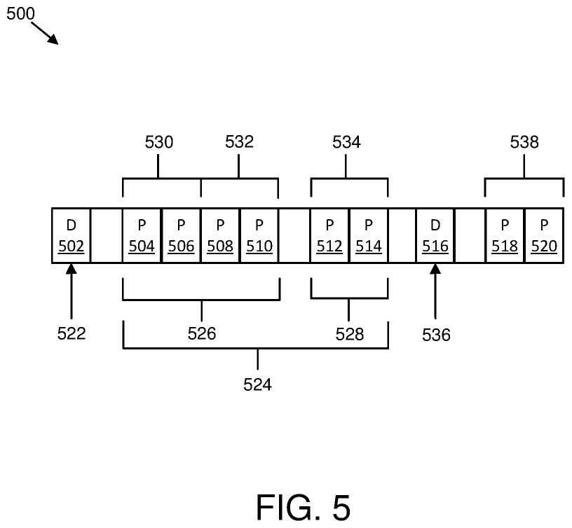

An illustration of the second embodiment for retransmission when TBoMS is applied and there are multiple TOTs is shown in FIG. 5.

FIG. 5 is a timing diagram illustrating one embodiment of retransmission of portions if TBoMS is applied and multiple TOTs exists. The timing diagram 500 illustrates a first DCI (“D”) 502, PUSCH transmissions (“P”) 504, 506, 508, 510, 512, and 514, a second D 516, and P 518 and 520. At a time 522, the D 502 is a DCI with TBoMS UL grant with 2 TOTs. A TBoMS 524 (M=6, L=2, n=3) includes P 504, 506, 508, 510, 512, and 514. The TBoMS 524 includes TOT1 (l=0) 526 and TOT2 (l=1) 528. Further, the TOT1 526 includes a first portion (portion 0 (m0=2)) 530 (e.g., P 504, 506) and a second portion (portion 1 (m1=2)) 532 (e.g., P 508, 510). Moreover, the TOT2 528 includes a third portion (portion 2 (m2=2)) 534 (e.g., P 512, 514). At a time 536, the D 516 is a DCI with retransmission of only portion 0 530 (e.g., bit field can be “100”). A retransmission 538 includes P 518 and 520 (e.g., retransmission of portion 0 (m0=2)).

In some embodiments, a combination of the following may apply to embodiments described herein: 1) a maximum number of slots that can be contained within a portion are pre-configured, semi-statically signaled, and/or dynamically indicated: 2) a maximum number of slots that can be contained within a portion are specific to each TOT and not more than the number of slots within a TOT: 3) a minimum number of slots that can be contained within a portion are pre-configured, semi-statically signaled, and/or dynamically indicated: 4) if the UE is configured and/or indicated to apply TBoMS, then CBG based PUSCH transmissions are not applied: 5) a separate (e.g., new) bitfield in the UL grant is used to indicate which portions need to be retransmitted—a bitfield size can be variable depending on scheduled slots for TBoMS, maximum allowed and/or calculated portions, minimum allowed and/or calculated portions, or some combination thereof: 6) existing field, such as CBGTI, can be reused to indicate which portions need to be retransmitted if CBG based PUSCH transmissions are not allowed—a bitfield size can be variable depending on scheduled slots for TBoMS, maximum allowed and/or calculated portions, minimum allowed and/or calculated portions, or some combination thereof;

7) a number of portions and duration for each portion can be implicitly determined based on how RV is applied—if more than on RV is applied with RV cycling over the entire duration of slots, then each of the portion duration can be implicitly determined based on the RV indication and corresponding slots over which same RV is applied—for example, if RV0 is applied to first 2 slots, RV2 is applied to next 2 slots, then the first portion can be assumed to be over first 2 slots, second portion can be assumed to be over next 2 slots, and so forth—in another example, the number of portions and duration for each portion are determined based on the number of slots with the same RV—for example, with N=2, if RV0 is applied to first 2 slots then n=2 (min(N,2)) portions with each portion corresponding to each of the two slots associated to RV0, RV2 is applied to next 3 slots then n=2 (min(N,3)) portions with first portion corresponding to first and second slots of the three slots associated to RV2 and the second portion corresponding to third slot of the three slots associated to RV2—in another example, with N=3, if RV0 is applied to first 2 slots then n=2 (min(N,2)) portions with each portion corresponding to each of the two slots associated to RV0, RV2 is applied to next 3 slots then n=3 (min(N,3)) with each portion corresponding to each of the three slots associated to RV0—the maximum of portions is based on the value of N and the maximum number of slots associated with the same RV—the grant for retransmission (with NDI bit not toggled and same HARQ process number), indicates the RV in the RV-field and an additional bitfield in the grant indicating which of the portions of the multi-slot PUSCH corresponding to the indicated RV is to be retransmitted. In some examples, the same RV may be applied to one or more TOTs. In some examples, different RVs may be used for different TOTs, and the number of portions and duration for each portion are determined based on the number of slots with a TOT:

8) a number of portions and duration for each portion can be implicitly determined based on how rate-matching is applied—if rate matching is applied separately for each slot or a sub-set of slots, then the portion duration can be assumed to be over one slot or over a sub-set of slots, respectively: 9) a number of portions and duration for each portion can be implicitly determined based on number of TOTs and number of slots within a TOT: 10) if a maximum number of portions is less than the number of TOTs that are scheduled, then in some implementations, a portion can cross a TOT boundary: and 11) a number of portions and duration for each portion can be implicitly determined or can be configured and/or indicated based on the numerology. For example, if a larger SCS such as 480 kHz or 960 kHz is applied, then a larger number of slots within a portion can be contained in comparison to some smaller SCS such as 15 kHz or 30 kHz.

In a third embodiment, there may be scheduling opportunities and/or occasions for retransmissions of a partial TB. According to the third embodiment, when a UE is scheduled with TBoMS and at least two sets of non-contiguous slots (e.g., two TOTs), then the UE can be indicated with a retransmission of a portion of the scheduled duration before the end of an initial transmission of an entire TBoMS. This means that the gNB can transmit a DCI indicating retransmission of the portion that is already received and/or decoded by gNB. In this case, the same HARQ process number is indicated, an NDI bit is not toggled, and the bitfield indicating retransmissions of portions is signaled to indicate which portions need to be retransmitted. However, the UE is not expected to be scheduled for the retransmission before the end of an entire initial (e.g., previous) transmission round.

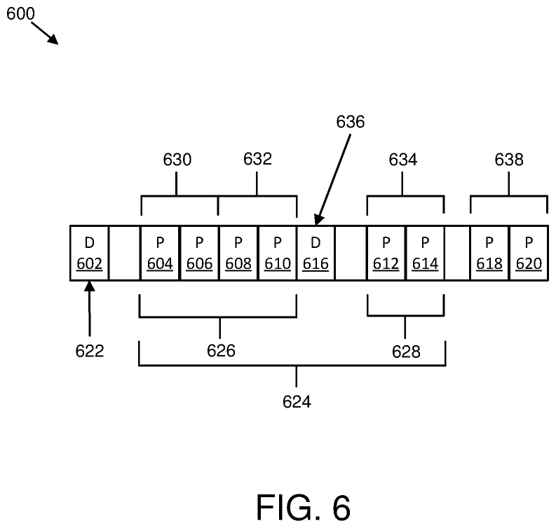

An example of the third embodiment is illustrated in FIG. 6 for if retransmission for already transmitted portions is indicated before the end of an initial (e.g., previous) transmission round of entire TBoMS.

FIG. 6 is a timing diagram 600 illustrating one embodiment of an early retransmission indication for partial TBoMS. The timing diagram 600 illustrates a first DCI (“D”) 602, PUSCH transmissions (“P”) 604, 606, 608, 610, 612, and 614, a second D 616, and P 618 and 620. At a time 622, the D 602 is a DCI with TBoMS UL grant with 2 TOTs. A TBoMS 624 (M=6, L=2, n=3) includes P 604, 606, 608, 610, 612, and 614. The TBoMS 624 includes TOT1 (l=0) 626 and TOT2 (l=1) 628. Further, the TOT1 626 includes a first portion (portion 0 (m0=2)) 630 (e.g., P 604, 606) and a second portion (portion 1 (m1=2)) 632 (e.g., P 608, 610). Moreover, the TOT2 628 includes a third portion (portion 2 (m2=2)) 634 (e.g., P 612, 614). At a time 636, the D 616 is a DCI with retransmission of only portion 0 630 (e.g., bit field can be “10”) before the end of the entire TBoMS. A retransmission 638 includes P 618 and 620 (e.g., retransmission of portion 0 (m0=2)).

In some embodiments, the bitfield size for retransmission indication may be shorter and may depend on a number of portions that have already been transmitted. For example, if 8 portions are determined for TBoMS, then the bitfield size of up to 8 can be used. If the gNB has only received 4 portions (and yet to receive remaining portions after a gap), then the gNB can indicate retransmission after the first 4 portions with only a bitfield size of 4 instead of 8.

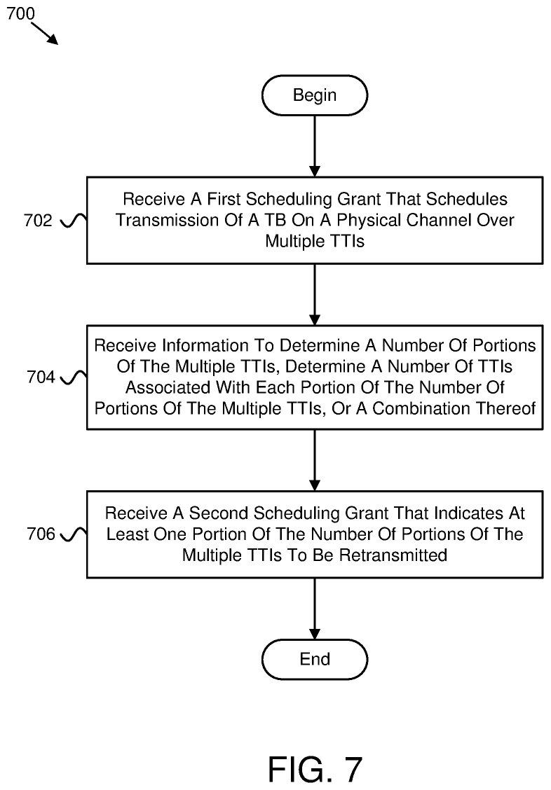

FIG. 7 is a flow chart diagram illustrating one embodiment of a method 700 for retransmitting portions of a TB. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a device, a first scheduling grant that schedules transmission of a TB on a physical channel over multiple TTIs. In some embodiments, the method includes receiving 704 information to determine a number of portions of the multiple TTIs, determine a number of TTIs associated with each portion of the number of portions of the multiple TTIs, or a combination thereof. In certain embodiments, the method includes receiving 706 a second scheduling grant that indicates at least one portion of the number of portions of the multiple TTIs to be retransmitted.

In certain embodiments, the multiple TTIs comprises a subset of contiguous TTIs scheduled for the transmission of the TB on the physical channel, and wherein the number of portions of the multiple TTIs is less than or equal to a number of the multiple TTIs. In some embodiments, the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs. In various embodiments, the method 700 further comprises determining the number of portions of the multiple TTIs based on a maximum number of portions, a minimum number of TTIs within a portion, a maximum number of TTIs within a portion, or some combination thereof.

In one embodiment, the method 700 further comprises determining the number of portions of the multiple TTIs based on a number of redundancy versions (RVs) for the transmission of the TB over the multiple TTIs, wherein a duration for each portion of the number of portions of the multiple TTIs is determined based on a duration corresponding to a single RV. In some embodiments, the method 700 further comprises determining the number of portions of the multiple TTIs based on a rate matching unit for the transmission of the TB over the multiple TTIs, wherein a duration for each portion of the number of portions of the multiple TTIs is determined based on a duration corresponding to the rate matching unit.

In one embodiment, the method 700 further comprises determining the number of portions of the multiple TTIs based on a number of TTIs indicated for transmission of the TB over the multiple TTIs, wherein, in response to the number of TTIs being below a threshold, the processor to determine that a duration of one portion is equal to one TTI.

In some embodiments, the method 700 further comprises determining the number of portions of the multiple TTIs based on a number of transmission occasions for the multiple TTIs, wherein a transmission occasion comprises a segment of contiguous TTIs of the multiple TTIs. In various embodiments, in response to the number of transmission occasions being below a threshold, the processor to determine that a duration of one portion is equal to a duration of one transmission occasion. In one embodiment, the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

In certain embodiments, to receive the second scheduling grant, the receiver receives the second scheduling grant after a start of the scheduled transmission of the TB and before an end of the scheduled transmission of the TB, and wherein the second scheduling grant indicates a bit field with a bitmap size equal to a number of portions received prior to the second scheduling grant. In some embodiments, the number of portions to be retransmitted are scheduled for transmission after an end of the multiple TTIs. In various embodiments, the transmission of the TB on the physical channel over multiple TTIs comprises the transmission of the TB on a PUSCH over multiple slots.

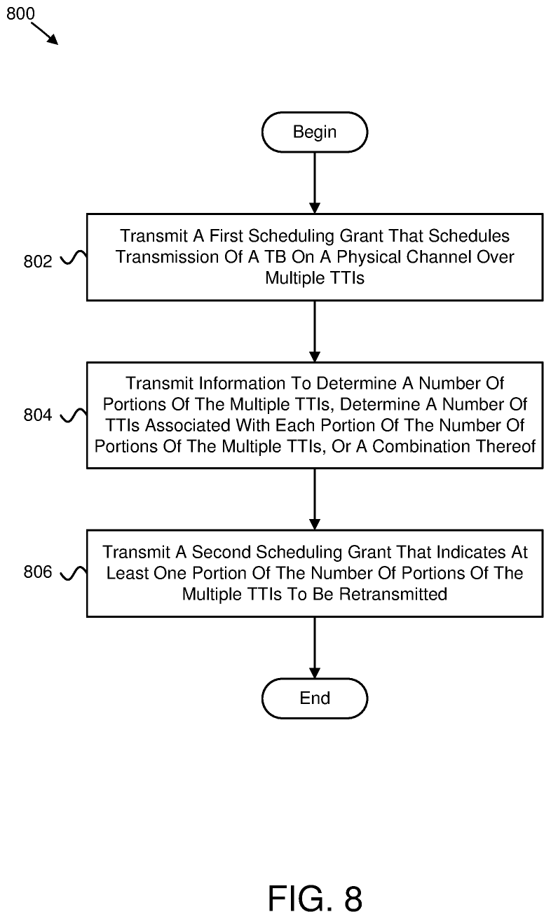

FIG. 8 is a flow chart diagram illustrating another embodiment of a method 800 for retransmitting portions of a TB. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802, at a device, a first scheduling grant that schedules transmission of a TB on a physical channel over multiple TTIs. In some embodiments, the method includes transmitting 804 information to determine a number of portions of the multiple TTIs, determine a number of TTIs associated with each portion of the number of portions of the multiple TTIs, or a combination thereof. In certain embodiments, the method includes transmitting 806 a second scheduling grant that indicates at least one portion of the number of portions of the multiple TTIs to be retransmitted.

In certain embodiments, the multiple TTIs comprises a subset of contiguous TTIs scheduled for the transmission of the TB on the physical channel, and wherein the number of portions of the multiple TTIs is less than or equal to a number of the multiple TTIs. In some embodiments, the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs. In various embodiments, the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

In one embodiment, the second scheduling grant is received after a start of the scheduled transmission of the TB and before an end of the scheduled transmission of the TB, and wherein the second scheduling grant indicates a bit field with a bitmap size equal to a number of portions received prior to the second scheduling grant. In certain embodiments, the number of portions to be retransmitted are scheduled for transmission after an end of the multiple TTIs. In some embodiments, the transmission of the TB on the physical channel over multiple TTIs comprises the transmission of the TB on a PUSCH over multiple slots.

In one embodiment, an apparatus comprises: a receiver to: receive a first scheduling grant that schedules transmission of a TB on a physical channel over multiple TTIs: receive information to determine a number of portions of the multiple TTIs, determine a number of TTIs associated with each portion of the number of portions of the multiple TTIs, or a combination thereof: and receive a second scheduling grant that indicates at least one portion of the number of portions of the multiple TTIs to be retransmitted.

In certain embodiments, the multiple TTIs comprises a subset of contiguous TTIs scheduled for the transmission of the TB on the physical channel, and wherein the number of portions of the multiple TTIs is less than or equal to a number of the multiple TTIs.

In some embodiments, the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs.

In various embodiments, the apparatus further comprises a processor to determine the number of portions of the multiple TTIs based on a maximum number of portions, a minimum number of TTIs within a portion, a maximum number of TTIs within a portion, or some combination thereof.

In one embodiment, the apparatus further comprises a processor to determine the number of portions of the multiple TTIs based on a number of redundancy versions (RVs) for the transmission of the TB over the multiple TTIs, wherein a duration for each portion of the number of portions of the multiple TTIs is determined based on a duration corresponding to a single RV.

In some embodiments, the apparatus further comprises a processor to determine the number of portions of the multiple TTIs based on a rate matching unit for the transmission of the TB over the multiple TTIs, wherein a duration for each portion of the number of portions of the multiple TTIs is determined based on a duration corresponding to the rate matching unit.

In one embodiment, the method further comprises a processor to determine the number of portions of the multiple TTIs based on a number of TTIs indicated for transmission of the TB over the multiple TTIs, wherein, in response to the number of TTIs being below a threshold, the processor to determine that a duration of one portion is equal to one TTI.

In some embodiments, the apparatus further comprises a processor to determine the number of portions of the multiple TTIs based on a number of transmission occasions for the multiple TTIs, wherein a transmission occasion comprises a segment of contiguous TTIs of the multiple TTIs.

In various embodiments, in response to the number of transmission occasions being below a threshold, the processor to determine that a duration of one portion is equal to a duration of one transmission occasion.

In one embodiment, the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

In certain embodiments, to receive the second scheduling grant, the receiver receives the second scheduling grant after a start of the scheduled transmission of the TB and before an end of the scheduled transmission of the TB, and wherein the second scheduling grant indicates a bit field with a bitmap size equal to a number of portions received prior to the second scheduling grant.

In some embodiments, the number of portions to be retransmitted are scheduled for transmission after an end of the multiple TTIs.

In various embodiments, the transmission of the TB on the physical channel over multiple TTIs comprises the transmission of the TB on a PUSCH over multiple slots.

In one embodiment, a method at device, the method comprises: receiving a first scheduling grant that schedules transmission of a TB on a physical channel over multiple TTIs: receiving information to determine a number of portions of the multiple TTIs, determine a number of TTIs associated with each portion of the number of portions of the multiple TTIs, or a combination thereof: and receiving a second scheduling grant that indicates at least one portion of the number of portions of the multiple TTIs to be retransmitted.

In certain embodiments, the multiple TTIs comprises a subset of contiguous TTIs scheduled for the transmission of the TB on the physical channel, and wherein the number of portions of the multiple TTIs is less than or equal to a number of the multiple TTIs.

In some embodiments, the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs.

In various embodiments, the method further comprises determining the number of portions of the multiple TTIs based on a maximum number of portions, a minimum number of TTIs within a portion, a maximum number of TTIs within a portion, or some combination thereof.

In one embodiment, the method further comprises determining the number of portions of the multiple TTIs based on a number of redundancy versions (RVs) for the transmission of the TB over the multiple TTIs, wherein a duration for each portion of the number of portions of the multiple TTIs is determined based on a duration corresponding to a single RV.

In some embodiments, the method further comprises determining the number of portions of the multiple TTIs based on a rate matching unit for the transmission of the TB over the multiple TTIs, wherein a duration for each portion of the number of portions of the multiple TTIs is determined based on a duration corresponding to the rate matching unit.

In one embodiment, the method further comprises determining the number of portions of the multiple TTIs based on a number of TTIs indicated for transmission of the TB over the multiple TTIs, wherein, in response to the number of TTIs being below a threshold, the processor to determine that a duration of one portion is equal to one TTI.

In some embodiments, the method further comprises determining the number of portions of the multiple TTIs based on a number of transmission occasions for the multiple TTIs, wherein a transmission occasion comprises a segment of contiguous TTIs of the multiple TTIs.

In various embodiments, in response to the number of transmission occasions being below a threshold, the processor to determine that a duration of one portion is equal to a duration of one transmission occasion.

In one embodiment, the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

In certain embodiments, to receive the second scheduling grant, the receiver receives the second scheduling grant after a start of the scheduled transmission of the TB and before an end of the scheduled transmission of the TB, and wherein the second scheduling grant indicates a bit field with a bitmap size equal to a number of portions received prior to the second scheduling grant.

In some embodiments, the number of portions to be retransmitted are scheduled for transmission after an end of the multiple TTIs.

In various embodiments, the transmission of the TB on the physical channel over multiple TTIs comprises the transmission of the TB on a PUSCH over multiple slots.

In one embodiment, an apparatus comprises: a transmitter to: transmit a first scheduling grant that schedules transmission of a TB on a physical channel over multiple TTIs: transmit information to determine a number of portions of the multiple TTIs, determine a number of TTIs associated with each portion of the number of portions of the multiple TTIs, or a combination thereof: and transmit a second scheduling grant that indicates at least one portion of the number of portions of the multiple TTIs to be retransmitted.

In certain embodiments, the multiple TTIs comprises a subset of contiguous TTIs scheduled for the transmission of the TB on the physical channel, and wherein the number of portions of the multiple TTIs is less than or equal to a number of the multiple TTIs.

In some embodiments, the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs.

In various embodiments, the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

In one embodiment, the second scheduling grant is received after a start of the scheduled transmission of the TB and before an end of the scheduled transmission of the TB, and wherein the second scheduling grant indicates a bit field with a bitmap size equal to a number of portions received prior to the second scheduling grant.

In certain embodiments, the number of portions to be retransmitted are scheduled for transmission after an end of the multiple TTIs.

In some embodiments, the transmission of the TB on the physical channel over multiple TTIs comprises the transmission of the TB on a PUSCH over multiple slots.

In one embodiment, a method at a device comprises: transmitting a first scheduling grant that schedules transmission of a TB on a physical channel over multiple TTIs: transmitting information to determine a number of portions of the multiple TTIs, determine a number of TTIs associated with each portion of the number of portions of the multiple TTIs, or a combination thereof; and transmitting a second scheduling grant that indicates at least one portion of the number of portions of the multiple TTIs to be retransmitted.

In certain embodiments, the multiple TTIs comprises a subset of contiguous TTIs scheduled for the transmission of the TB on the physical channel, and wherein the number of portions of the multiple TTIs is less than or equal to a number of the multiple TTIs.

In some embodiments, the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs.

In various embodiments, the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

In one embodiment, the second scheduling grant is received after a start of the scheduled transmission of the TB and before an end of the scheduled transmission of the TB, and wherein the second scheduling grant indicates a bit field with a bitmap size equal to a number of portions received prior to the second scheduling grant.

In certain embodiments, the number of portions to be retransmitted are scheduled for transmission after an end of the multiple TTIs.

In some embodiments, the transmission of the TB on the physical channel over multiple TTIs comprises the transmission of the TB on a PUSCH over multiple slots.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a first scheduling grant that schedules transmission of a transport block (TB) on a physical channel over multiple transmission time intervals (TTIs);
receive information to determine a number of portions of the multiple TTIs, determine a number of TTIs associated with each portion of the number of portions of the multiple TTIs, or a combination thereof; and
receive a second scheduling grant that indicates at least one portion of the number of portions of the multiple TTIs to be retransmitted.

2. The UE of claim 1, wherein the multiple TTIs comprises a subset of contiguous TTIs scheduled for the transmission of the TB on the physical channel, and wherein the number of portions of the multiple TTIs is less than or equal to a number of the multiple TTIs.

3. The UE of claim 1, wherein the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs.

4. The UE of claim 1, wherein the at least one processor is configured to cause the UE to determine the number of portions of the multiple TTIs based on a maximum number of portions, a minimum number of TTIs within a portion, a maximum number of TTIs within a portion, or a combination thereof.

5. The UE of claim 1, wherein the at least one processor is configured to cause the UE to determine the number of portions of the multiple TTIs based on a number of redundancy versions (RVs) for the transmission of the TB over the multiple TTIs, wherein a duration for each portion of the number of portions of the multiple TTIs is determined based on a duration corresponding to a single RV.

6. The UE of claim 1, wherein the at least one processor is configured to cause the UE to determine the number of portions of the multiple TTIs based on a rate matching unit for the transmission of the TB over the multiple TTIs, wherein a duration for each portion of the number of portions of the multiple TTIs is determined based on a duration corresponding to the rate matching unit.

7. The UE of claim 1, wherein the at least one processor is configured to cause the UE to determine the number of portions of the multiple TTIs based on a number of TTIs indicated for transmission of the TB over the multiple TTIs, wherein, in response to the number of TTIs being below a threshold, the processor to determine that a duration of one portion is equal to one TTI.

8. The UE of claim 1, wherein the at least one processor is configured to cause the UE to determine the number of portions of the multiple TTIs based on a number of transmission occasions for the multiple TTIs, wherein a transmission occasion comprises a segment of contiguous TTIs of the multiple TTIs.

9. The UE of claim 8, wherein, in response to the number of transmission occasions being below a threshold, the at least one processor is configured to cause the UE to determine that a duration of one portion is equal to a duration of one transmission occasion.

10. The UE of claim 1, wherein the second scheduling grant indicates a bit field with a bitmap size equal to the number of portions, and, if a bit is indicated as “1”, then retransmission for a corresponding portion of the number of portions is performed and, if a bit is indicated as “0”, then the retransmission for the corresponding portion is not performed.

11. The UE of claim 1, wherein, to receive the second scheduling grant, the at least one processor is configured to cause the UE to receive the second scheduling grant after a start of the scheduled transmission of the TB and before an end of the scheduled transmission of the TB, and wherein the second scheduling grant indicates a bit field with a bitmap size equal to a number of portions received prior to the second scheduling grant.

12. The UE of claim 11, wherein the number of portions to be retransmitted are scheduled for transmission after an end of the multiple TTIs.

13. The UE of claim 1, wherein the transmission of the TB on the physical channel over multiple TTIs comprises the transmission of the TB on a PUSCH over multiple slots.

14. A method of a user equipment (UE), the method comprising:
receiving a first scheduling grant that schedules transmission of a transport block (TB) on a physical channel over multiple transmission time intervals (TTIs);
receiving information to determine a number of portions of the multiple TTIs, determine a number of TTIs associated with each portion of the number of portions of the multiple TTIs, or a combination thereof; and
receiving a second scheduling grant that indicates at least one portion of the number of portions of the multiple TTIs to be retransmitted.

15. A base station, comprising:
at least one memory; and
at least one processor coupled with the at least one memory and configured to cause the base station to:
transmit a first scheduling grant that schedules transmission of a transport block (TB) on a physical channel over multiple transmission time intervals (TTIs);
transmit information to determine a number of portions of the multiple TTIs, determine a number of TTIs associated with each portion of the number of portions of the multiple TTIs, or a combination thereof; and
transmit a second scheduling grant that indicates at least one portion of the number of portions of the multiple TTIs to be retransmitted.

16. A processor for wireless communication, comprising:
at least one memory; and
at least one controller coupled with at least one memory and configured to cause the processor to:
receive a first scheduling grant that schedules transmission of a transport block (TB) on a physical channel over multiple transmission time intervals (TTIs);
receive information to determine a number of portions of the multiple TTIs, determine a number of TTIs associated with each portion of the number of portions of the multiple TTIs, or a combination thereof; and
receive a second scheduling grant that indicates at least one portion of the number of portions of the multiple TTIs to be retransmitted.

17. The processor of claim 16, wherein the multiple TTIs comprises a subset of contiguous TTIs scheduled for the transmission of the TB on the physical channel, and wherein the number of portions of the multiple TTIs is less than or equal to a number of the multiple TTIs.

18. The processor of claim 16, wherein the multiple TTIs comprises a subset of noncontiguous TTIs scheduled for the transmission of the TB on the physical channel, and wherein each portion of the number of portions of the multiple TTIs is within a subset of contiguous TTIs of the multiple TTIs.

19. The processor of claim 16, wherein the at least one controller is configured to cause the processor to determine the number of portions of the multiple TTIs based on a maximum number of portions, a minimum number of TTIs within a portion, a maximum number of TTIs within a portion, or a combination thereof.

20. The processor of claim 16, wherein the at least one controller is configured to cause the processor to determine the number of portions of the multiple TTIs based on a number of redundancy versions (RVs) for the transmission of the TB over the multiple TTIs, wherein a duration for each portion of the number of portions of the multiple TTIs is determined based on a duration corresponding to a single RV.
